(19) United States
(12) Patent Application Publication
(10) Pub. No.: US 2021/0134075 A1
(43) Pub. Date: May 6, 2021

(54) System and Method for Implementing a Preventative Maintenance Schedule

(71) Applicant: Caterpillar Inc., Peoria, IL (US)

(72) Inventors: Richard A. Carpenter, Chillicothe, IL (US); Kyle B. Walton, Edelstein, IL (US); John J. Krone, Peoria, IL (US); Venkata Dandibhotla, Lakewood, CO (US); Yanchai Zhang, Dunlap, IL (US)

(73) Assignee: Caterpillar Inc., Peoria, IL (US)

(21) Appl. No.: 16/672,182

(22) Filed: Nov. 1, 2019

(51) Int. Cl. G07C 5/00; G07C 5/08; B01D 35/00; B01D 35/143; B01D 37/04

(52) U.S. Cl. CPC G07C 5/006; G07C 5/085; B01D 37/046; B01D 35/005; B01D 35/143; G07C 5/008

(57) ABSTRACT

A computer implemented preventative maintenance schedule can includes a plurality of predetermined maintenance intervals. A replaceable maintenance item may be initially assigned to an initially assigned maintenance interval. A performance data associated with the replaceable maintenance item may be measured and an estimated end of useful life may be determined based on the performance data. The estimated end of useful life is compared to the assigned maintenance interval and, if warranted, the assigned maintenance schedule is modified.

### TECHNICAL FIELD

This patent disclosure relates generally to preventative maintenance of a machine and, more particularly, to scheduling the maintenance of replacement items like filters and fluids used on the machine.

### BACKGROUND

Various types of machines for performing useful work in fields such as construction, mining and excavation, and agriculture are powered by a primary mover such as an internal combustion engine. Internal combustion engines combust a mixture of air or another oxidizer and hydrocarbon based fuel such as diesel in a combustion chamber to convert the latent chemical energy to a useful motive force that can be applied for physical work. The harnessed power may propel the machine about a worksite or operate a work implement on the machine to perform a task. The internal combustion engine may be associated with various systems to facilitate operation and these associated systems often include maintenance items that require periodic maintenance and service. Examples of maintenance items include filters to screen and remove contaminates in various filtration tasks, including air filters to filter intake air and fuel filters to screen the fuel used in combustion. Filters may become loaded or clogged over time requiring cleaning or replacement. Other examples of maintenance items include fluids (other than fuel) that are utilized in engine operation, including lubricant to lubricate the moving components of the engine and engine coolant to remove heat generated by combustion. These engine fluids may degrade or breakdown over time, especially if they are continuously cycled through the engine in a closed fluid circuit.

Preventative maintenance schedules may be implemented to guide the periodic maintenance and service of the maintenance items. Preventative maintenance schedules may be based on a predetermined number of operating hours or on a predetermined duty cycle such as miles driven. The maintenance intervals in the preventative maintenance schedule are often determined theoretically during design or empirically under specified test conditions. The actual conditions in which the internal combustion engine is used may be vastly different than the empirical conditions that support the preventative maintenance schedule. This presents potential negative consequences, for example, a maintenance item may actually require maintenance or service well before its scheduled maintenance interval that could negatively affect engine operation or damage the engine. Alternatively, a maintenance item may be arbitrarily serviced in advance of the onset of actual conditions that would necessitate service. For example, a filter may be discarded and replace according to a preventative maintenance schedule while the filter still has significant operative capacity, resulting in economic waste.

Systems and methods have been proposed to augment or replace predetermined preventative maintenance schedules based on concurrent diagnostics and analysis regarding the maintenance item. For example, U.S. Patent Publication No. 2016/0116392 describes monitoring operating parameters associated with a maintenance item such as a filter and using that information to estimate the actual condition and remaining life of the filter. The present disclosure is similarly directed to implementing preventative maintenance schedule.

### SUMMARY

The disclosure describes, in one aspect, a preventative maintenance system for the scheduled maintenance of an internal combustion engine. The preventative maintenance system includes a sensor operatively associated with a replaceable maintenance item to measure a performance data associated with the item. The preventative maintenance system also includes a computer readable data map of a preventative maintenance schedule for the replaceable maintenance item that includes a plurality of predetermined maintenance intervals. The replaceable maintenance item may be initially assigned to an initially assigned maintenance schedule with a predetermined maintenance interval. The preventative maintenance system also includes a processor configured to estimate an estimated end of useful life for the replaceable maintenance item based on the performance data, compare the estimated end of useful life to the initially assigned predetermined maintenance interval, and to modify the assigned maintenance schedule if the estimated end of useful life does not match the predetermined maintenance interval.

In another aspect, the disclosure describes a method of preventative maintenance for an internal combustion engine. The method includes storing in non-transitory memory a computer readable data map of a preventative maintenance schedule for a replaceable maintenance item including a plurality of predetermined maintenance intervals. The replaceable maintenance item may be initially assigned to an initially assigned maintenance schedule with predetermined maintenance interval in the data map. The method measures a performance data associated with the replaceable maintenance item and estimates an estimated end of useful life for the replaceable maintenance item based on the performance data. The method then compares the estimated end of useful life with the initially assigned predetermined maintenance interval for the replaceable maintenance item and, if warranted modifies the assigned maintenance schedule.

In yet another aspect, the disclosure describes a kit for retrofitting an internal combustion engine that includes an I/O interface to communicate with a sensor associated with a replaceable maintenance item and to receive a performance data measured by the sensor. The kit also includes non-transitory memory in which is stored a computer readable data map of a preventative maintenance schedule for the replaceable maintenance item. The preventative maintenance schedule includes a plurality of predetermined maintenance intervals. The replaceable maintenance item is initially assigned to an assigned preventative maintenance schedule with an initially assigned predetermined maintenance interval. The kit also includes a processor configured to estimate an estimated end of useful life for the replaceable maintenance item based on the performance data, compare the estimated end of useful life to the initially assigned predetermined maintenance interval, and to modify the assigned maintenance schedule if the estimated end of useful life does not match the predetermined maintenance interval initially assigned to replaceable maintenance item.

### BRIEF DESCRIPTION OF THE DRAWINGS

FIG. 1 is a schematic representation of an internal combustion engine and associated systems that may be operatively associated with a preventative maintenance system for examining, evaluating, and scheduling maintenance for various replaceable maintenance items.

FIG. 2 is a schematic block diagram of the preventative maintenance system of FIG. 1 including various hardware components and communication channels for implementing the system.

FIG. 3 is a representative flow diagram depicting steps and operations in the form of a computer executable process, routine, or algorithm the preventative maintenance system may conduct to examine, evaluate and schedule maintenance of a replaceable maintenance item.

FIG. 4 is a representative flow diagram of a computer executable process, routine, or algorithm for evaluating and modifying the preventative maintenance schedule for a replaceable maintenance item.

### DETAILED DESCRIPTION

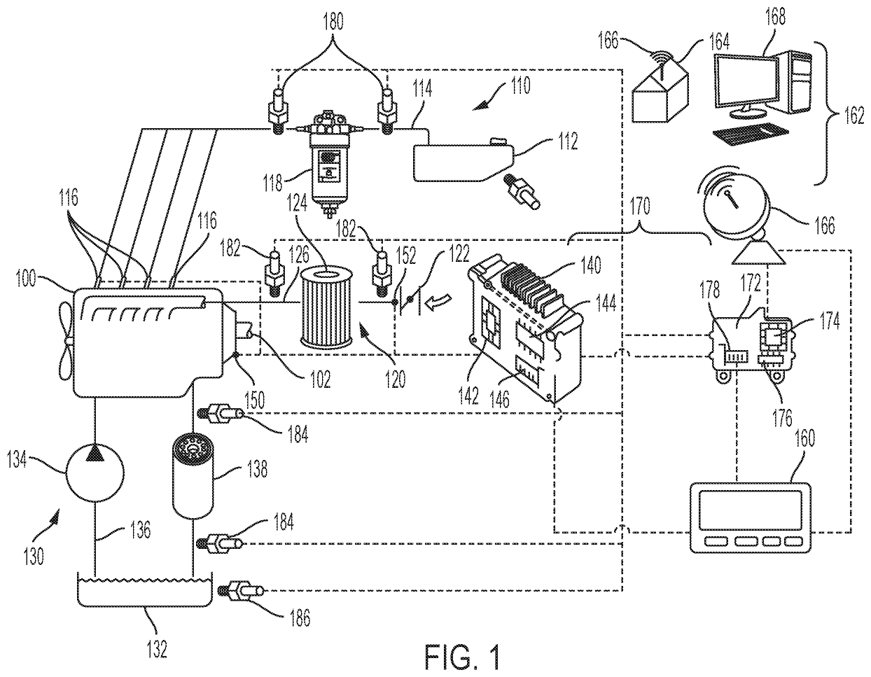

Now referring to the drawings, wherein like reference numbers refer to like elements, there is illustrated in FIG. 1 a prime mover in the embodiment of an internal combustion engine 100 intended to generate operative power for powering a machine. The internal combustion engine 100 can combust a mixture of air and fuel and can convert the released energy to motive power in the form of rotational motion that may be transferred to other applications by a rotating crankshaft 102. The internal combustion engine 100 can have any suitable configuration such as a diesel burning compression ignition engine, a spark ignited gasoline engine, a hybrid engine, a dual fuel engine burning liquid fuel and natural gas, or the engine may be a fuel combusting turbine, steam boiler or other type of combustion engine. The internal combustion engine 100 may power any kind of mobile or stationary work machine associated with industries such as mining, construction, agriculture, transportation, landscaping, oil and gas excavation, manufacturing and industry, and the like. For example, the machine may be an earth-moving machine, such as a wheel loader, excavator, dump truck, backhoe, motor grader, material handler or the like. In addition to propelling the machine, the internal combustion engine can provide power for operating other implements associated with the machine such as loading buckets, dozing blades, cutters, hammers and the like. In other embodiments, the internal combustion engine 100 may be utilized in stationary industrial applications to power generators, fluid pumps, etc.

To facilitate operation, the engine 100 may be associated with various systems. For example, to deliver fuel to the engine for combustion, a fuel system 110 can be associated with the engine that includes a fuel tank 112 or reservoir to store a liquid or gaseous fuel such as diesel, gasoline or nature gas. The engine 100 communicates with the tank 112 via a fuel line 114 that may be a hose or tubing that terminates at a plurality of injectors 116 included with the engine to inject fuel to the combustion chambers. To remove contaminants from the fuel, and to remove water that may be entrained in the fuel and that would negatively impact the combustion process, the fuel system 110 includes a fuel filter 118 combined or associated with a fuel-water separator. The fuel filter 118 can be an internal cartridge type device that includes a removable filter cartridge or element in an external housing that can screen out impurities while allowing fuel to pass onto engine 100. To provide air that may be used as an oxidizer for combustion, the engine 100 can be operatively associated with an intake air system 120. The intake air system 120 can receive air from the environment through an adjustable throttle valve 122 such as a butterfly valve that can meter the amount of air directed to the engine. In various embodiments, to increase the amount of intake air that may be directed to the engine 100, a turbocharger may be included with the intake air system 120 and may be disposed in the air circuit between the throttle valve 122 and the engine. To remove debris and contaminants in the air, the intake air system 120 can include an air filter 124 disposed in an air line 126 upstream of the engine 100. The air filter 124 may be a pleated paper element permeable to air but adapted to remove particulates therefrom.

To provide oil or other lubricants for lubricating the moving parts of the internal combustion engine 100, an oil system 130 can be associated with the engine. The oil system 130 includes an oil reservoir 132 such as an oil pan in which a liquid lubricant of desired viscosity is contained. To direct lubricant to the engine 100 when running, an oil pump 134 that can draw and pressurize lubricant can be disposed in an oil circuit 136 communicating between the reservoir 132 and the engine 100. The oil circuit 136 can be configured to return the lubricant to the reservoir for repeated use. To remove any contaminants or impurities the lubricant may receive from the engine 100, an oil filter 138 is disposed in the return portion of the oil circuit 136. The oil filter 138 may be a self-contained spin-on device containing an internal membrane and an exterior shell configured to receive lubricant from the engine, thereby forcing flow across the membrane and allowing the lubricant to return to the reservoir 132. Another example of a system that may be operatively associated with the engine is a coolant system, which may also include a coolant filter to remove impurities from the liquid coolant.

As discussed above, various components of the fuel system 110, air system 120, oil system 130 and others may be considered replaceable maintenance items. Due to typical operating conditions the replaceable maintenance items may wear or deteriorate to the point of requiring replacement. For example, the fuel filter 118, air filter 124, and oil filter 138 through their intended function of removing and capturing contaminants and debris will become clogged and restrict flow of the associated process fluids. As another example, the process fluids themselves may degrade due to repeated use and require replacement. Also, the process fluids may be consumed by operation of the engine, and require replacement or replenishment. Oil stored in the oil reservoir 132, because it is repeatedly cycled through the internal combustion engine 100 during operation, is an example of a consumable process fluid. To timely replace or service these replaceable maintenance items, a preventative maintenance schedule may be utilized by the operator of the machine associated with the engine. As familiar to those of skill in the art, a preventative maintenance schedule establishes periodic or regular intervals for the replacement and service of maintenance items based on their expected service life. The intervals are typically based on a predetermined number of operating hours or a predetermined duty cycle, which may be theoretically or empirically determined. Similarly, air filters are designed to block dust, dirt and other environmental contaminants from entering in the engine. Over the period of time, the air filters may get clogged. Consequently, an engine with a clogged air filter is forced to work harder, resulting in poor fuel economy, and higher emissions

To coordinate and regulate operation of the internal combustion engine 100 and its associated systems, an engine control module (ECM) 140 also referred to as an engine control unit (ECU) or electronic control unit 140, may be operatively associated with the engine and may be disposed onboard the machine that the engine powers. The ECM 140 can be a programmable computing device and can include one or more microprocessors 142, a non-transitory computer readable and/or writeable memory 144 or a similar storage medium, input/output interfaces 146, and other appropriate circuitry for processing computer executable instructions, programs, applications, and data to regulate performance of the engine 100. The ECM 140 may be configured to process digital data in the form of binary bits and bytes. The ECM 140 can communicate with various sensors to receive data about engine performance and operating characteristics and can responsively control various actuators to adjust that performance. To send and receive electronic signals to input data and output commands, the ECM 140 can be operatively associated with a communication network having a plurality of terminal nodes connected by data links or communication channels. For example, as will be familiar to those of skill in the art of automotive technologies, a controller area network (“CAN”) can be utilized that is a standardized communication bus including physical communication channels conducting signals conveying information between the ECM and the sensors and actuators associated with the internal combustion engine 100. However, in possible embodiments, the ECM 140 may utilize other forms of data communication such as radio frequency waves like Wi-Fi, optical wave guides and fiber optics, or other similar technologies. In an embodiment, the ECM 140 may be a preprogrammed, dedicated device that is factory installed on the machine for regulation and control of the internal combustion engine 100 and may have limited reprograming capacity.

A dedicated task for the ECM 140 may be to control the speed and/or torque output of the internal combustion engine 100. To determine the instantaneous operating speed of the engine, the ECM 140 can communicate with an engine speed sensor 150 that can measure the speed in terms of revolutions per minute (“RPMs”) of the crankshaft 102. For a diesel combusting compression ignition engine 100, the ECM 140 can communicate with the plurality of injectors 116 to regulate the amount of fuel introduced to the engine and adjust the speed. In addition, the ECM 140 can also communicate with the air intake system 120 to selectively control the quantity of air drawn in and thus the air/fuel ratio. In particular, the ECM 140 can communicate with an air flow sensor 152 disposed in the air line 126 that can measure mass intake air flow in, for example, cubic meters (m³) and can measure intake air temperature in Fahrenheit or Celsius. Other engine tasks the ECM may regulate include valve timing of the intake and exhaust valves, the coolant system associated with the engine, and the exhaust system including operation of an exhaust gas recirculation valve if included.

To interface with an operator or technician, the ECM 140 can be operatively associated with an operator interface display 160, also referred to as a human-machine interface (“HMI”). The operator interface display 160 can be an output device to visually present information to a human operator regarding operation and regulation of the engine 100 and machine by the ECM 140. The operator interface display 160 can be a liquid crystal display (“LCD”) capable of presenting numerical values, text descriptors, graphs, charts and the like regarding operation. In other embodiments, other visual displays may be used such as a cathode ray tube. The operator interface display 160 may have capacities such as a touchscreen to receive input from a human operator to direct instructions or requests to the ECM 140. In other embodiments, other interface devices may be included such as dials, knobs, switches, keypads, keyboards, mice, printers, etc. Other types of visual and/or audible alarms may be also be included with the operator interface display 160.

The ECM 140 may be operatively associated with a telematics system 162 to communicate with an external or remote location 164 to send status information from the ECM 140 regarding engine and systems operation and possibly receive operating instructions and commands. For example, if the machine powered by the engine 100 is performing operations about a large-scale worksite such as a mine or construction site, the remote location 164 may be an onsite office or trailer to accommodate workers, engineers, and technicians. The telematics system 162 can include a transmitter/receiver 166 positioned on the machine associated with the engine 100 and in communication with the ECM 140 and a corresponding transmitter/receiver 166 can be located at the remote location 164. The transmitter/receivers 166 can exchange information via signals using wireless protocols such as WiFi, Bluetooth, or cellular communications. The remote location 164 can also be associated with a remote computer system 168 providing management and server capabilities for processing the information exchanged through the telematics system 162. The information can be used to assist in worksite management and planning decisions.

In an aspect of the disclosure, to monitor and schedule replacement of the replaceable maintenance items, a computer executable maintenance system 170 may be operatively associated with the internal combustion engine 100 and the various support systems. In contrast to conventional preventative maintenance schemes that rely on predetermine intervals, the disclosed preventative maintenance system 170 can utilize information about the current operating conditions of the engine 100 for more accurate estimation of the actual condition of the replaceable maintenance items. Monitoring actual, real time conditions also avoids prematurely or belated replacement of maintenance items such as filters. In a further aspect of the disclosure, the preventative maintenance system 170 may be implemented as part of the ECM 140 that is factory installed on the machine powered by the engine or may be implemented as an aftermarket system for retrofit installation on the machine. When the preventative maintenance system 170 is implemented as original equipment functionality with the ECM 140, it can utilize the sensors and actuators operatively associated with the ECM. When the preventative maintenance system 170 is implemented as an aftermarket component, it may be configured to communicate with the existing sensors and actuators directly, through the ECM, or may be packaged as kit with some or all of the necessary sensors and actuators for retrofit installation. A possible advantage of implementing the preventative maintenance system 170 as a dedicated or aftermarket installation is that use of system resources may be optimized.

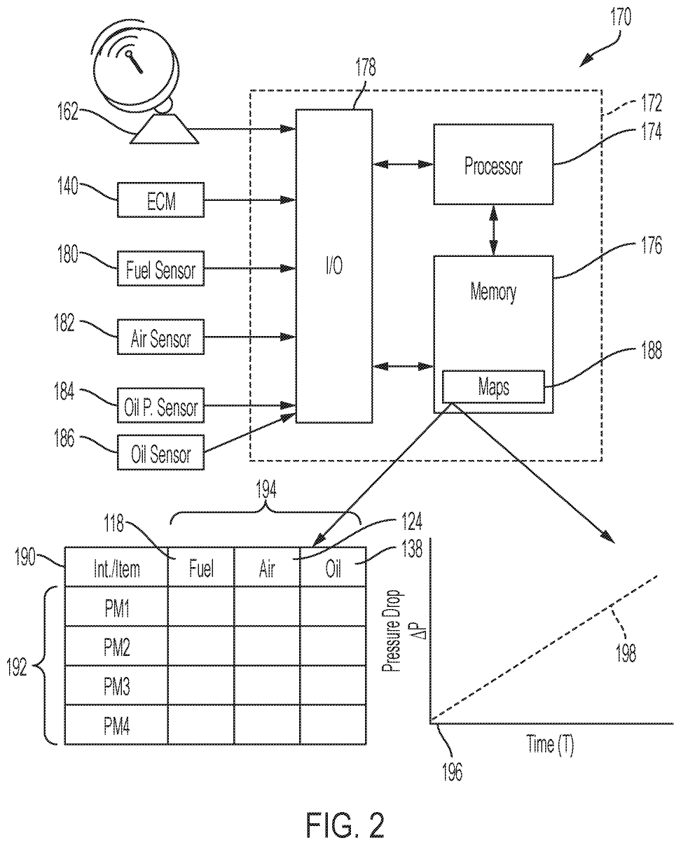

Referring to FIGS. 1 and 2, in the embodiment where the preventative maintenance system 170 is implemented as an aftermarket installation or as a dedicated hardware unit, the system can include a dedicated or standalone electronic controller 172 for operating in parallel with and independently of the ECM 140. The standalone electronic controller 172 can include one or more microprocessors 174 or similar electronic circuitry that may be general purpose or specific purpose device for executing the logic functions necessary for estimating the physical condition of the replaceable maintenance items. Example of suitable microprocessors include programmable logic devices such as field programmable gate arrays (“FPGA”), dedicated or customized logic devices such as application specific integrated circuits (“ASIC”), gate arrays, a complex programmable logic device, or any other suitable type of circuitry or microchip. To assist operation of the microprocessor 174, the electronic controller 172 can also include non-transitory computer readable and writeable memory 176 such as read only memory (“ROM”), random access memory (“RAM”), EPROM memory, flash memory, or another suitable storage medium like magnetic or optical storage. To communicate with the ECM 140 and the other sensors and actuators associated with the internal combustion engine 100, the standalone electronic controller 172 can include an input/output interface 178 such as data ports, serial ports, parallel ports, USB ports, jacks, and the like. The standalone electronic controller 172 can utilize any suitable forms of communication protocol for data communication including sending and receiving digital or analog signals synchronously, asynchronously, or elsewise. The standalone electronic controller 172 can be operatively associated with other devices and functionality for data processing and transmission including device drivers, digital-to-analog convertors and the like. In embodiments of the disclosure including a telematics system 162, the standalone electronic controller 172 can also communicate with the transmitter/receiver 166 of the telematics system to transmit information to a remote location 164.

To receive and monitor operating parameters and characteristics regarding the replaceable maintenance items, the standalone electronic controller 172 can communicate with a plurality of independent or shared sensors and actuators associated with the preventative maintenance system 170. For example, the pressure drop or pressure difference of a fluid flowing across, i.e., entering and exiting, a filter resulting from the filter's resistance to flow may indicated or may be analyzed to assess the physical condition of the filter. To measure the pressure difference across the fuel filter 118, a pair of fuel pressure sensors 180 can be positioned upstream and downstream of the fuel filter and can be in fluid communication with the fuel line 114. Sensor placed upstream and downstream of a fluid passage may be referred to differential pressure sensors. Accordingly, the difference in the fluid pressure measured by the upstream and downstream fuel pressure sensors 180 provides the pressure difference or drop across the fuel filter 118. The fuel pressure sensors 180 can utilize any suitable pressure sensing technology such as piezoelectric effects, capacitive effects, stress or strain-gauges, electromagnetic effects, or the like and can measure in absolute or gauge pressure. The fuel pressure sensors 180 can access the fuel line 114 via a threaded connection or tap.

In addition to measuring the pressure drop across the fuel filter 118, the preventative maintenance system 170 can include a pair of intake air pressure sensors 182 positioned upstream and downstream of the air filter 124 to measure the drop in air pressure thereacross. Similarly, the preventative maintenance system 170 and can include a pair of oil pressure sensors 184 positioned upstream and downstream of the oil filter 138 to measure the drop in oil pressure thereacross. In another embodiment, the preventative maintenance system 170 can be configured to measure the quality or condition of consumable fluids like the lubricant in lubricant system 130, which may be subject to chemical degradation or breakdown after extended use. To measure a property of the lubricant, one or more oil sensors 186 can be positioned in the oil reservoir 132 to contact the lubricant. The oil sensor 186 may measure properties such as temperature, viscosity, density, or dielectric constant as well as the flow rate or quantity oil flowing in the oil circuit 136 at a given time. A first set of suitable sensors may be associated with the preventative maintenance system 170 to measure the physical conditions and physical properties of other replaceable maintenance items. A second set of suitable sensors may be associated with the preventative maintenance system 170 to measure the chemical properties of replaceable maintenance items.

Referring to FIG. 2, to facilitate the operation of the preventative maintenance system 170 in the embodiment of an aftermarket kit, the standalone electronic controller 172, can be operatively associated with a plurality of data files or data maps 188 that may be electronically readable/writable data arrays stored in the memory 176. The data maps 188 can include variables, data, and parameters that can be retrieved, interpreted, and processed by the microprocessor 174 associated with standalone electronic controller 172 for discerning information and making decisions regarding the replaceable maintenance items. The data maps 188 can further organize the data therein to simplify searching and indexing. Examples of data maps include lookup tables, relational databases, matrixes, or any other suitable data structures. In the factory installed embodiment wherein the preventative maintenance system 170 is implemented as part of the ECM 140, the data maps may be stored in memory 144.

One data map 188 may be a data map of a routine preventative maintenance schedule 190 including a plurality of predetermined maintenance intervals 192 for the replaceable maintenance items. By way of example only and without limitation or exclusion, the routine preventative maintenance schedule 190 can be visualized as chart or table in which a plurality of predetermined maintenance intervals 192 are presented (e.g., PM 1, PM 2, PM 3, PM 4) as rows that each correspond to a different temporal period. For example, PM 1 may correspond to a 250 hour interval, PM 2 may correspond to a 500 hour interval, PM 3 may correspond to a 1000 hour interval, and PM 4 may correspond to a 2500 hour interval. Different replaceable maintenance items 194 may be presented as columns (e.g., fuel filter 118, air filter 124, oil filter 138) and may be classified or assigned to individual predetermined maintenance intervals 192 based initially based upon theoretical or empirical estimates of the item's useful life. Accordingly, to determine the scheduled maintenance period for a particular replaceable maintenance item, the preventative maintenance system 170 can look up the assigned predetermined maintenance interval 192 in the routine preventative maintenance schedule 190. Different or additional predetermined maintenance intervals 192 and/or replaceable maintenance items 194 can be included in the data map of the routine preventative maintenance schedule 190.

Another example of a data map 188 can be anticipated performance ratings 196 associated with the replaceable maintenance items 194. In a particular example, the anticipated performance ratings 196 may be a measurable performance parameter or performance data associated with the replaceable maintenance items at a particular duration of operation or duty cycle. For a filter such as the fuel filter 118, air filter 124, or oil filter 138, the performance data may be the pressure drop between the inlet and outlet across the filter due to the resistance to fluid flow. As explained, during the course of operation, a filter may retain contaminants increasing the resistance to flow and thus increasing the pressure drop. In an example, the anticipated performance ratings 196 may be presented as a two axis chart with the pressure drop, differential pressure, or delta pressure (AP) represented on the Y axis and the total operational time (T) that the filter has been in service represented on the X axis. A line 198 can be plotted indicating the anticipated pressure drop for a filter at particular durations of operation. The anticipated performance ratings may be determined theoretically by design or empirically by testing and may be provided by manufacturers or vendors of the replaceable maintenance items. It will be appreciated that multiple charts of the anticipated performance ratings 196 can be generated to reflect different types of performance data or criteria such as viscosity, density, or dielectric constant for a process fluid like lubricant oil.

### INDUSTRIAL APPLICABILITY

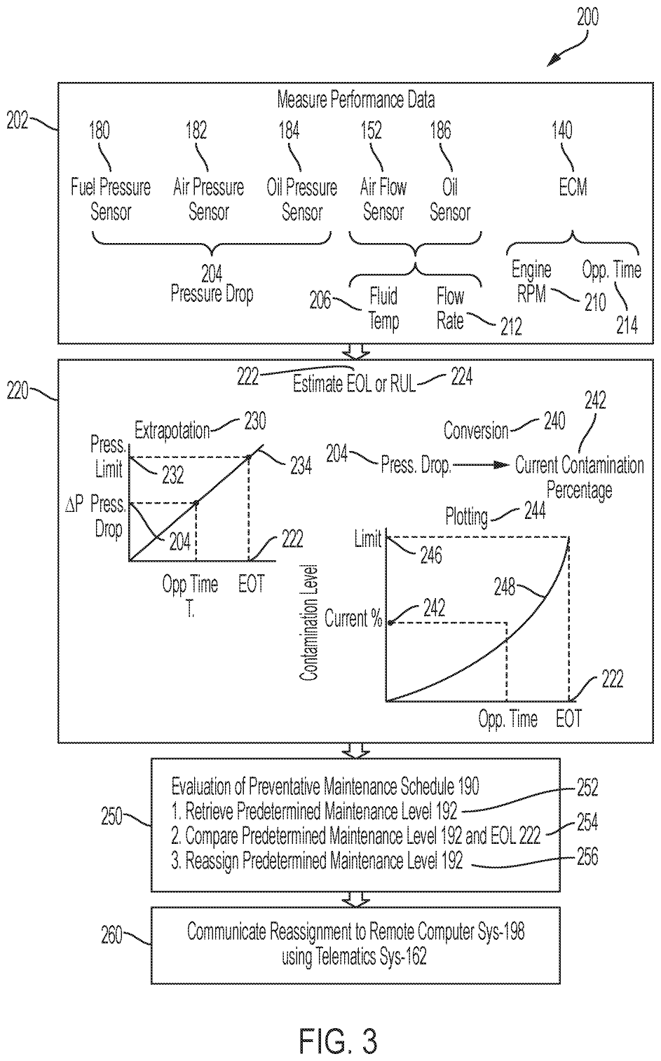

Referring to FIG. 3, there is illustrated a flow diagram 200 of an exemplary process that the preventative maintenance system 170 can utilize to estimate the remaining useful life or the end of useful life for a replaceable maintenance item associated with an internal combustion engine or similar prime mover to implement and augment a preventative maintenance schedule. The flow diagram 200 may include a series of steps or instructions implemented as computer executable software code in the form of an application or program. In various embodiments, the flow diagram 200 can be implemented in either the ECM 140 for a factory installed implementation or in the standalone electronic controller 172 for an aftermarket implementation. In an initial measurement step 202, the preventative maintenance system 170 can measure a plurality of performance data associated with the replaceable maintenance item. For example, in the matter of a filter such as the fuel filter 118, air filter 124, or oil filter 138, the performance data may be the measured pressure drop 204 or the differential pressure across the filter. For computer implemented preventative maintenance system 170, the measured pressure drop 204 can be transmitted as non-transitory electronic signals from fuel pressure sensor 180, air pressure sensor 182, and/or oil pressure sensor 184 disposed upstream and downstream of the respective filters. The measured pressure drop 204 can be represented in any suitable unit of measure such as Pascals (Pa).

The preventative maintenance system 170 can receive additional data regarding operating characteristics and parameters to assist in assessing the performance data. For example, the fluid temperature 206 of the process fluid associated with the subject filters 180, 182, 184 can be received by the preventative maintenance system 170. In the example of an air filter 124, the air flow sensor 152 associated with the intake air system 120 can measure and transmit the ambient temperature of the intake air. In the example of an oil filter 138, the oil sensor 186 in fluid communication with the oil reservoir can measure and transmit the fluid temperature 206 associated with lubricant. It will be appreciated that the temperature of the process fluid may affect its viscosity or density and can be an important factor affecting performance data like the measured pressure drop 204.

The preventative maintenance system 170 can also receive information regarding the engine speed 210 of the internal combustion engine 100 in RPM and flow rate 212 or intake air volume in cubic meters. The ECM 140 may measure the engine speed 210 and mass flow rate 212 using the engine speed sensor 150 and air flow sensor 152 respectively and transmit the data as non-transitory electronic signals to the preventative maintenance system 170. The preventative maintenance system 170 may also measure the flow rate 212 or flow volume of oil in the oil system 130 using the oil sensor 186. The preventative maintenance system 170 can also receive the total operating time 214 associated with the respective filter. The total operating time 214 may be the time the filter has been placed in operative service from installation until the time of evaluation, i.e., the time measurements of the performance data and other parameter are taken. The total operating time 214 may be based upon a setting stored in the ECM 140 or the standalone electronic controller 172 by a technician when installing the filter or other replaceable service item. The ECM 140 and/or standalone electronic controller 172 can monitor or track the operational time of the engine 100 after installation to determine the total operating time 214 in, for example, hours.

In a subsequent estimation step 220, preventative maintenance system 170 can estimate the end of useful life (EOL) 222 or a remaining useful life (RUL) 224 of the replaceable maintenance item based on the measured performance data and related information. The EOL 222 may be an estimation of the total useful time that a replaceable maintenance item will be able to function for its intended purpose. In the example of a fuel filter 118, air filter 124, or oil filter 138, the EOL 222 may occur when the pressure drop across the filter indicates that the filter has become significantly contaminated or clogged and is unacceptably restricting flow. The indicated pressure drop may be based on a predetermined limit. In a similar manner, the RUL 224 represents the remaining time from the point of evaluation to the end of useful life (EOL). The RUL 224 may be obtained by subtracting the total operating time 214, measured in hours for example, from the estimated EOL 222.

In a simple example, the EOL 222 may be evaluated by an extrapolation sub-step 230 using a two axis chart. Pressure drop (AP) may be represented on the Y-axis and time (T) may be represented on the X-axis. The measured pressure drop 204 can be plotted on the Y-axis and the total operating time 214 can be plotted on the X-axis. A performance limitation such as a pressure drop limit 232 that represents the pressure drop of the filter at EOL may also be plotted on the Y-axis. The pressure drop limit 232 may be provided by the manufacturer and may exist as a setting or data point retrievable from, for example, from a data map or lookup table similar to the anticipated performance ratings 196. A performance line 234 can be plotted through the measured pressure drop 204 and the total operating time 214 and extrapolated to the pressure drop limit 232. The preventative maintenance system 170 can estimate the EOL 222 of the respective filter using the X-axis.

In another example, the preventative maintenance system 170 can execute a conversion sub-step 240 to convert the performance data as measured to another parameter to more accurately estimate the EOL 222. In the example of a fuel filter 118, air filter 124, or oil filter 138, the measured pressure drop 204 can be converted to a current contamination percentage 242 of the filter. The current contamination percentage 242 may demarcate the used and the unused capacity of the filter at the time of evaluation and may be estimated within the spectrum or range between a newly installed, uncontaminated filter and an unacceptably contaminated or clogged filter. The measured pressure drop 204 can be converted to a current contamination percentage 242 based on data that relates pressure drop to a percentage of contamination or loading of the filter, which may be provided in a data map of the anticipated performance ratings 196 provided by and determined empirically by the manufacturer. In a plotting sub-step 244, the current contamination percentage 242 and the total operating time 214 can be plotted on a two-axis chart that graphs the contamination level on the Y-axis against time (T) on the X-axis. A contamination limit 246 may also be plotted on the Y-axis that represent a fully contaminated or clogged filter. The contamination limit 246 may be obtained from a data map of the anticipated performance ratings 196 from the manufacturer.

A performance curve 248 can be plotted through the intersection of the current contamination percentage 242 and the total operating time 210 and extrapolated to the contamination limit 246. The performance curve 248 can be based on anticipated contamination levels or percentages for future operation of the filter since the current total operating time 214, which data may also be included in a data map of the anticipated performance ratings 196. The performance curve 248 may be a nonlinear curve on the chart because, as will be appreciated, as the filter clogs, its capacity to trap contaminants is reduced at an increasing rate. In other words, less filter area or filtration media is present to remove similar quantities of contamination assuming similar quantities of process fluid are directed through the filter. The performance curve 248 may account for other non-linearities in performance such as relations between temperature and mass flow. The performance curve 248 may be extrapolated to the contamination limit 246, and the preventative maintenance system 170 can estimate the EOL 222 of the respective filter using time on the X-axis.

In an aspect of the disclosure, the preventative maintenance system 170 can use the EOL 222 estimated by extrapolation, conversion, or some other method to adjust the preventative maintenance schedule 190. For example, referring to the preventative maintenance schedule 190 in FIG. 2, the initially assigned maintenance interval 192 for a particular replaceable maintenance item may differ with respect to the estimated EOL 222 associated with the item. The EOL 222 may indicate the replaceable maintenance item will have a longer useful life for the prevailing operating conditions than the initially assigned maintenance interval 192 indicates, or that the item will reach the end of its useful life before the maintenance interval 192 expires.

Accordingly, in an evaluation step 250, the preventative maintenance system 170 can evaluate the preventative maintenance schedule 190 to determine whether to maintain or adjust the initially assigned maintenance interval 192. In a retrieval sub-step 252, the preventative maintenance system 170 can look up and retrieve the initially assigned predetermined maintenance interval 192 for the replaceable maintenance item from the preventative maintenance schedule 190. In a comparison sub-step 254, the initially assigned predetermined maintenance interval 192 and the estimated EOL 222 are evaluated to determine if adjustment of the maintenance interval, either upwards or downwards, is warranted. For example, the initially assigned maintenance interval 192 for an oil filter may be 250 hours (e.g., PM 1), but the presently estimated EOL 222 may indicate the oil filter will remain functional for 500 hours (PM 2). In an reassignment step 226, the preventative maintenance system 170 may rewrite the data in the data map associated with the preventative maintenance schedule 190 to change the preventative maintenance interval 192 for the air filter, for example, to 500 hours (PM 2). The preventative maintenance system 170 may incorporate rules and logic to apply qualifiers or tolerances to the maintenance intervals 192 to judge whether adjustment is warranted. If the evaluation step 250 does not indicate that adjustment is warranted, the preventative maintenance system 170 maintains the initially assigned maintenance interval 192.

Referring to FIGS. 1 and 2, in an aspect of the disclosure, the preventative maintenance system 170 can communicate the results of the evaluation step 250 to operators or technicians to better schedule preventative maintenance for the internal combustion engine 100. For example, the preventative maintenance system 170 in a communication step 260 can use the telematics system 162 to communicate the results to a remote location 164. Technicians and/or remote computer systems 168 can adjust preventative maintenance schedules for the replaceable maintenance items on the machine, and may cooperatively schedule maintenance for a plurality or fleet of machines operating at a large worksite, for example, to substitute machines or schedule orders for replaceable maintenance part. A possible advantage of the disclosure is that prolonging preventative maintenance reduces downtime of an engine and associated machine improving operational efficiency.

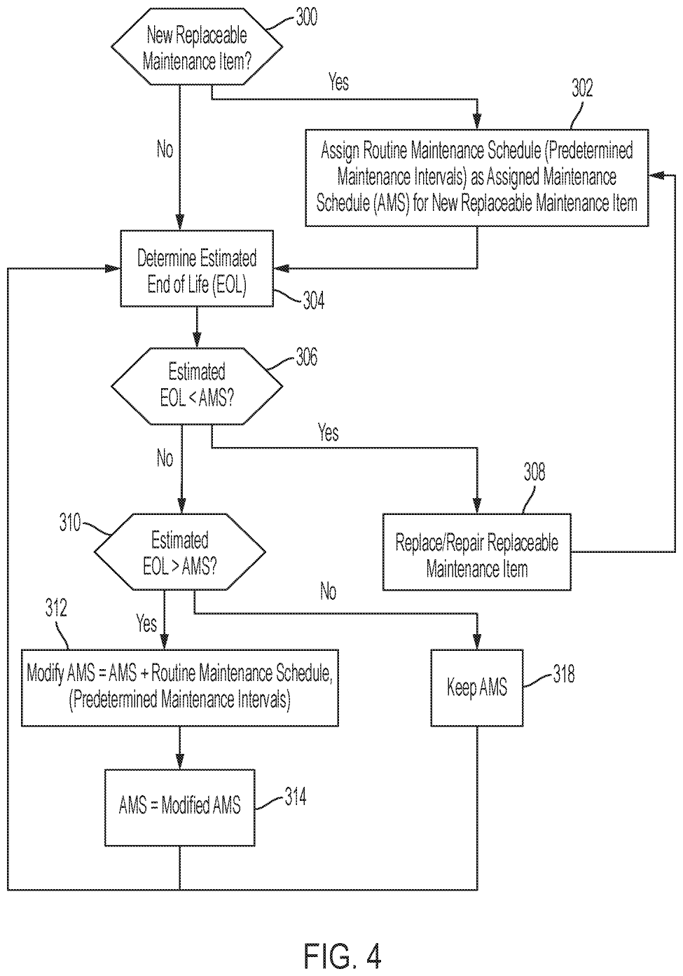

Referring to FIG. 4, there is illustrated an embodiment of a process for implementing the preventative maintenance system 170. In an initial item check step 300, the process checks if the replaceable maintenance item 194 at issue is a new item. If so, the process in an assignment step 302 assigns the routine preventative maintenance schedule 190 with predetermined maintenance intervals 192 associated with the new replaceable maintenance item 194, as may be determined by the manufacturer, as an assigned maintenance schedule, with the new replaceable maintenance item 194 initially assigned to a predetermined maintenance interval. If the replaceable maintenance item 194 is not new, the process may assume a predetermined maintenance interval has already been assigned to replaceable maintenance item 194.

To estimate the end of useful life for replaceable maintenance item 194, which may be based on measured performance data obtained during engine operation, the process may conduct an estimation step 304, which may use any of the available end of life estimation procedures described in estimation step 220 in FIG. 3. The process in a first comparison step 306 compares the estimated EOL with the assigned maintenance schedule for the replaceable maintenance item 194, for example, by querying whether the estimated EOL is less than the predetermined maintenance interval assigned to the replaceable maintenance item 194. If the first comparison step 306 determines the estimated EOL determined directly from the operating conditions is less than the predetermined maintenance interval 194 from the assigned maintenance schedule for the replaceable maintenance item 194, and thus it has exceeded its useful life, the process can proceed to a repair/replacement step 308 in which the replaceable maintenance item 194 is repaired or replaced as appropriate.

If the first comparison step 306 determines the estimated EOL is above or exceeds the assigned predetermined maintenance interval 192, the process can conduct a second comparison step 310 again to determining if the estimated EOL is greater than the predetermined maintenance interval assigned to the replaceable maintenance item 194. If so, the process can modify the assigned maintenance schedule for the replaceable maintenance item 194 in a schedule modification step 312. For example, the routine preventative maintenance schedule 190 provides for predetermined maintenance intervals 192, this assigned maintenance schedule can be modified by moving the replaceable maintenance item 194 into the next predetermined maintenance interval. This avoids prematurely replacing items that are still within their useful life. In a subsequent reassignment step 314, the preventative maintenance schedule for the replaceable maintenance item 194 as modified is assigned as the new assigned preventative maintenance schedule and the process may start again. If, however, the second comparison step determines the estimated EOL and the assigned predetermined maintenance interval 192 are comparable or accurate, the process may conclude in a conclusion step 318 to keep the assigned maintenance schedule for the replaceable maintenance item 194.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A preventative maintenance system for service of a replaceable maintenance item comprising:
a sensor configured to measure performance data associated with a replaceable maintenance item;
a computer readable data map including a routine maintenance schedule with a plurality of predetermined maintenance intervals for the replaceable maintenance item and an assigned maintenance schedule with an assigned maintenance interval for the replaceable maintenance item; and
a processor configured to estimate an estimated end of useful life for the replaceable maintenance item based on the performance data, compare the estimated end of useful life with the assigned maintenance schedule, and modify the assigned maintenance schedule if the estimated end of useful life does not match the assigned maintenance interval.

2. The preventative maintenance system of claim 1, wherein the predetermined maintenance intervals are based on a predetermined number of operating hours or on a predetermined duty cycle.

3. The preventative maintenance system of claim 2, wherein the processor is configured estimate the estimated end of useful life for the replaceable maintenance item based in part upon a total operating time associated with the replaceable maintenance item.

4. The preventative maintenance system of claim 3, wherein the processor is configured to extrapolate from the performance data to a performance limit retrieved from a computer readable map of anticipated performance ratings stored in the non-transitory memory to estimate the estimated end of useful life for the replaceable maintenance item.

5. The preventative maintenance system of claim 1, wherein the replaceable maintenance item is selected from the group comprising a fuel filter, an air filter, and oil filter.

6. The preventative maintenance system of claim 5, wherein the performance data is measured pressure drop.

7. The preventative maintenance system of claim 1, wherein the replaceable maintenance item is lubricant, and the performance data is selected from the group comprising viscosity, density, and dielectric constant.

8. The preventative maintenance system of claim 1, wherein the processor is included with an engine control module factory installed with the internal combustion engine.

9. The preventative maintenance system of claim 1, the processor is included with a standalone electronic controller provided with an aftermarket kit.

10. The preventative maintenance system of claim 1, further comprising a telematics system to communicate reassignment of the replaceable maintenance item to a remote computer system.

11. A method of preventative maintenance for an internal combustion engine comprising:
storing a computer readable data map of a routine maintenance schedule including a plurality of predetermined maintenance intervals for a replaceable maintenance item and an assigned maintenance schedule with an assigned maintenance interval for the replaceable maintenance item;
measuring a performance data associated with the replaceable maintenance item;
estimating an estimated end of useful life for the replaceable maintenance item based on the performance data;
comparing the estimated end of useful life with the assigned maintenance interval for the replaceable maintenance item; and
modifying the assigned maintenance schedule if estimated end of useful life does not match the assigned maintenance interval.

12. The method of claim 11, further comprising tracking a total operating time associated with the replaceable maintenance item to estimate end of useful life for the replaceable maintenance item.

13. The method of claim 12, wherein the performance data is selected from the group comprising measured pressure drop, density, viscosity, or dielectric constant.

14. The method of claim 11, wherein the method is performed by an engine control module factory installed with the internal combustion engine.

15. The method of claim 11, wherein the method is performance by a standalone electronic controller retrofit to the internal combustion engine.

16. The method of claim 11, further comprising communicating the modified maintenance schedule to a remote computer system using a telematics system.

17. The method of claim 11, wherein the routine maintenance intervals are based on a predetermined number of operating hours or on a predetermined duty cycle.

18. A kit for retrofitting an internal combustion engine comprising:
an I/O interface configured to communicate with a sensor associated with a replaceable maintenance item and to receive a performance data measured by the sensor;
non-transitory memory storing a computer readable data map of a routine maintenance schedule for the replaceable maintenance item including a plurality of predetermined maintenance intervals and an assigned maintenance schedule with the replaceable maintenance item assigned to an assigned maintenance interval; and
a processor configured to estimate an estimated end of useful life for the replaceable maintenance item based on the performance data, compare the estimated end of useful life to the assigned maintenance schedule, and to modify assigned maintenance schedule if the assigned maintenance interval does not match the estimated end of useful life for the replaceable maintenance item.

19. The kit of claim 18, wherein the I/O interface is further configured to communicate with a telematics system to communicate reassignment of the replaceable maintenance item to a remote computer system.

20. The kit of claim 18, further comprising a differential sensor for measuring pressure drop across one of a fuel filter, an air filter, and an oil filter.
